(19) United States
(12) Patent Application Publication
(10) Pub. No.: US 2003/0076746 A1
(43) Pub. Date: Apr. 24, 2003

(54) Reversed time-keeping device (clock/watch)

(76) Inventor: Cardale Palmer, Las Vegas, NV (US)

Correspondence Address: Cardale Palmer, 81 W. Potter PL, Pahrump, NV, 89048, US

(21) Appl. No.: 09/982,386

(22) Filed: Oct. 18, 2001

(51) Int. Cl. G04B 19/04; G04B 19/06

(52) U.S. Cl. 368/80

(57) ABSTRACT

A method for maintaining the accuracy of time while viewing the standard hour, minute and seconds in a direction counter-clockwise to that of all normal clocks and/or watches, comprising the steps of setting the clock time on the normal correct hour and minute initially, with subsequent observation of movement of both the Hour hand, Minute hand and seconds indicator moving from a 12 O'Clock position towards the left positioning of each subsequent chronological time indicating feature, i.e. 1 O'Clock Hour position Mark and back to the 12 O'Clock Hour position mark in a continuous counter-clockwise time-keeping motion. The design of this clock complies with the requirements of a single claim as defined in 37 CFR □ 1.153 and the patent is requested to protect the utility of this article under (35 U.S.C. 101) and its ornamental looks under (35 U.S.C. 171).

### DETAILED DESCRIPTION

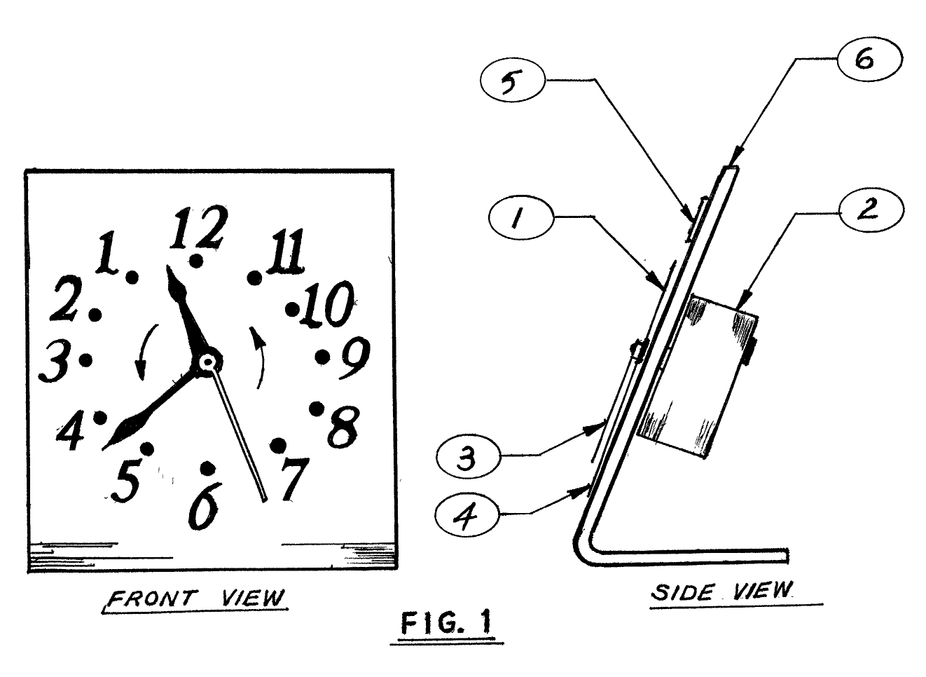

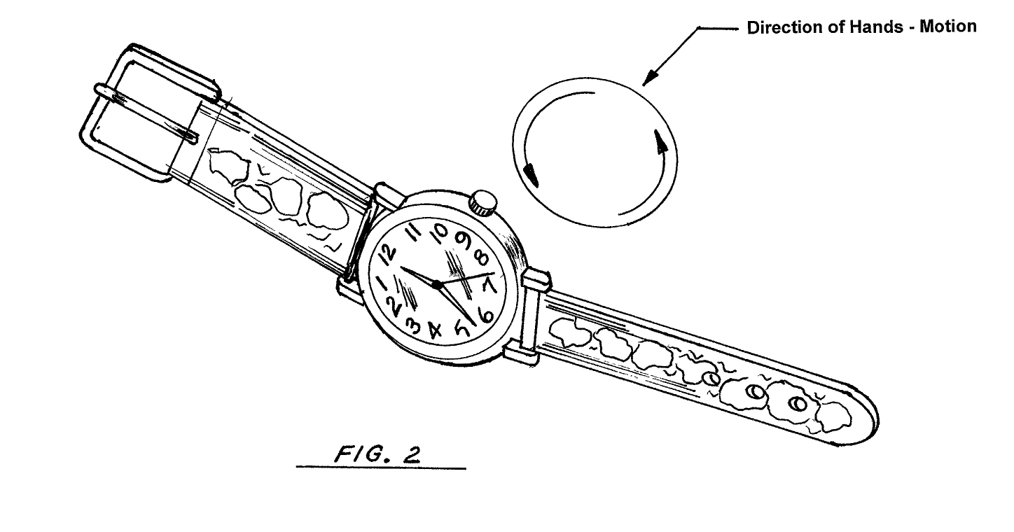

When the user sets the Hour Hand (1), as shown in (FIG. 1) for the reverse time-keeping clock and/or (FIG. 2) for the reverse time-keeping watch, to the 12:00 O'Clock position, and initiates battery power to the motor assembly (2), both the Hour Hand (1) and Minute Hand (3) advances in a direction to the left (counter-clockwise) through the sequential indicated Hourly designated graduations, keeping standard time for any applicable universal time-zone for which the clock's time is set for. The novel of this process is that the observer will be exposed to an aesthetically pleasing and new and innovative view of time reference.

The Second Hand indicator (4) rotates continuously in the counter-clockwise direction causing the Minute hand (3) to advance one graduation every 360 degree rotation of the Second Hand (4), and the Hour Hand (1) arrives at each Hour indicated graduation in a counter-clockwise direction, each 360 degree rotation of the Minute Hand (3). The clock or watch face is clearly graduated in Hourly indications (5), mounted on a base material which can be fabricated from aluminum, wood and/or durable plastic (6).

What I claim as my Invention is:

1. A method for viewing a time-keeping device observing the movement of the Hour, Minute and Second hand indicators (pointers) in a direction from a vertical 12 O'Clock indicated position towards the left, moving in a 360 degree direction back to the indicated 12 O'Clock indicated position, each rotation of the seconds indicator causing the minute indicator to move one graduated minute to the left and each total 360 degree left rotation of the graduated minute indicator to the left causing subsequent movement of the Hour indicator to move to a position left which indicates time causation of one hour.

2. A method as in claim 1 wherein the small battery powered electric motor is arranged in an assembly with Gears and small shafts which rotates the shaft when viewed from a frontal position, counter-clockwise.

3. A method as in claim 1 where a clock or watch face with reversed hour, minute and second indicated graduations are Chronologically arranged on the face equally spaced in 12 positions separated by 30 degrees for each hour representation and 6 degrees for each minute representation in a direction to the left (counter-clockwise) from a vertically located 12 O'Clock top position.

4. A clock or watch as in claim 1 wherein the time can be adjusted by means of an adjustment mechanism within the gearing to advance the Hour, Minute and/or Second Indicator Pointers.

5. A clock or watch as claimed in 1 comprised of a small battery driven clock motor assembly which processes the rotations from the motor's gear assembly on the basis of a timing parameter to produce an indication of actual clock time through an arrangement of gears producing a counter-clockwise motor shaft direction.
